(19) United States
(12) Patent Application Publication
(10) Pub. No.: US 2006/0026146 A1
(43) Pub. Date: Feb. 2, 2006

(54) Pay-per-patent-proof system and method

(76) Inventor: Israel Tvito, Hod Hasharon (IL)

Correspondence Address: DR. MARK FRIEDMAN LTD.;C/o Bill Polkinghorn, 9003 Florin Way, Upper Marlboro, MD, 20772, US

(21) Appl. No.: 11/185,772

(22) Filed: Jul. 21, 2005

Related U.S. Application Data
(60) Provisional application No. 60/599,569, filed on Aug. 9, 2004.

(30) Foreign Application Priority Data
Aug. 1, 2004 (IL) 163298

(51) Int. Cl. G06F 17/30

(52) U.S. Cl. 707/3

(57) ABSTRACT

A Pay-Per-Patent-Proof (PPPP) system for enables the user, for example an inventor, to submits a patent search application, which includes a description of the invention, for the purpose of assessing the patentability of an invention, and assessing the risk of patent infringement by implementation of the invention. The application is checked by a patent researcher. If a prior publication of the invention is provided, and as a result, the invention is not patentable, the user is charged for the patent search. If a prior publication is not provided, the user will not be charged. The billing sum can be dependent on the patent search and assessment parameters such as: response time; duration of search time in databaess relevant to the field of the invention; databases necessary for the search; and time of providing results after completion of the search and the assessment.

### FIELD AND BACKGROUND OF THE INVENTION

This application claims priority to U.S. Provisional Application No. 60/599,569, filed Sep. 8, 2004, herein incorporated by reference in its entirety.

The present invention relates to a patent search system and method.

The first step taken prior to submitting a patent application to the proper authorities is to check whether or not the invention is patentable. Most inventors consume many resources to search for prior publications with regard to their invention. In most cases, the inventions do not pass the search phase, since a prior claim was published vis-à-vis the invention or a similar idea related to it. A large portion of invention searches is made by patent attorneys, who are obviously familiar with the legal and technical structure of patents and thus, more qualified in searching the patent data base

Ever since the Internet and the information it contains became widely accessible, many inventors prefer to perform the preliminary patent search by themselves and save the patent attorney's fee. Usually, the inventors do not posses the needed relevant skills to minimize the search area and as a result, need to go over a tremendous amount of inventions. Even if the inventor manages to minimize the search area to a reasonable amount of patents, he does not know the legal and technical structure of which patents are written in and therefore, the inventor requires the services of a patent attorney.

Many inventors use the great accessibility of the World Wide Web free databases. These archives are published by patent offices from all over the world, on their web sites, and enable the inventors to evaluate their patents. Such web sites include: www.uspto.gov and www.espacenet.com. The benefit of these publications to the governments is a lighter workload.

In the past few years, several companies have been founded with the purpose of assisting the inventor in the search of similar inventions. These companies, such as “Thomson Corporation”, use web sites and advanced search engines such as: www.derwentcom, www.delphion.com and www.patentcafe.com to modify the search. There are also web sites, such as www.patentsearcbexpress.com, and www.nerac.com, which provide human web search information services and refer the inventor to earlier publications regarding most similar inventions and the field of the invention.

In the current situation, there is no patent service provider with a sincere desire to find a similar patent, to the one of the client has requested a search for, since there is a financial balance between finding and not finding an invention. Said balance is an outcome of the fact that the user pays the search fee anyhow, without any correlation with the search results. Furthermore, when applying a search application to a patent attorney the financial balance is violated, and to the wrong direction. Patent attorneys establish their income on editing and submitting inventions as patent applications, and as a result, have an obvious interest to ignore similar, but not exactly same inventions and proceed to submit the so-called invention and charge a greater fee.

### SUMMARY OF THE INVENTION

It is an object of the present invention to provide a pay-per-patent-proof system and method.

According to the present invention, a method for enabling a user performing a pay per patent search for the purpose of assessing the patentability of an invention is provided, the method including the following steps: (a) the user's entry via the Internet into a pay per patent search system, the per patent search system including: (i) a server, wherein the server is hosting a website loaded with dedicated software; (b) the user's filling a request to perform a patent search, wherein the request can include illustration means such as drawings, sketches, presentation, pictures, multimedia etc. and obligation to accept billing to his account, wherein the request includes a description of the invention for the patentability assessment of which the patent search is to be performed; (c) the user's receiving, from the pay per patent search system, a signed confirmation that is not changeable, as proof of submission of the request, confirmation of obligation to confidentiality, and proof of the date of the invention; (d) performing patent search by a patent researcher; (e) assessing the patentability of the invention by the patent researcher; and (f) delivery of the patent search and the patentability assessment results to the user.

According to further features in preferred embodiments of the invention, the method further including the step; (g) billing of the credit card according to the search results.

The term “biling”, for the purpose of this method, can also include user benefits, namely negative billing in which the user receives some of payment or other benefit, according to the result of patent search. The term “his account” and the term “user's account” as used in the specification and claims, refer to any accont throuh which the user can meet payment of the bill.

According to further features in preferred embodiments of the invention, the billing fee is none in the case that the assessment results do not indicate that the invaention is not patentable

According to further features in preferred embodiments of the invention, the billing sum increases according to the patent search and assessment results, which are selected from consisting of longer assessment time, a result indicating high likelihood of impatentability, and results indicating a higher risk of patent infringement in the case of implementation of the invention for which the patent search was performed.

According to further features in preferred embodiments of the invention, the method further including the steps; (g) the user confirms the billing fee; and (h) the user's account is billed.

According to another embodiment of the invention a method for enabling a user performing a pay per patent search for the purpose of assessing the patentability of an invention, and assessing the risk of patent infringement by implementation of the invention is provided, the method including the following steps: (a) the user's entry via the Internet into a pay per patent search system, the pay per patent search system including: (i) a server, wherein the server is hosting a website loaded with dedicated software; (b) the user's filling a request to perform a patent search, and obligation to accept billing to his account, wherein the request includes a description of the invention for the patentability assessment of which the search is to be performed; (c) the user's receiving, from the pay per patent search system, a signed confirmation that is not changeable, as proof of submission of the request, confirmation of obligation to confidentiality, and proof of the date of the invention; (d) performing patent search by a patent researcher; (e) assessing the patentability of the invention by the patent researcher; (f) assessing the risk of patent infringement in the case of implementation of the invention for which the patent search was performed; and (g) delivery of the patent search, the patentability assessment, and the assessment of risk of patent infringement results to the user.

According to further features in preferred embodiments of the invention, the method further including the step; (h) billing of the user's account according to the search results.

According to further features in preferred embodiments of the invention, the billing fee is none, in the case that the assessment results indicate neither that the invention is not patentable nor at risk of patent infringement in case of implementation.

According to further features in preferred embodiments of the invention, the billing sum increases according to the search and the assessment results, which are selected from consisting of longer assessment time, a result indicating high likelihood of impatentability, and results indicating a higher risk of patent infringement in the case of implementation of the invention for which the patent search was performed.

According to further features in preferred embodiments of the invention, the method further including the steps; (h) the user confirms the fee to be billed to his account; and (i) the user's account is billed.

According to another embodiment of the invention a method for enabling a user performing a pay per patent search for the purpose of assessing the patentability of an invention is provided, the method including the following steps: (a) the user's filling a request to perform a patent search, and obligation for payment, wherein the request includes a description of the invention for the patentability assessment of which the search is to be performed; (b) the user submits the request and obligation for payment to a patent researcher. (c) the user receives, from the patent researcher, a signed confirmation that is not changeable, as proof of submission of the request, confirmation of obligation to confidentiality, and proof of the date of the invention; (d) performing patent search by a patent researcher; (e) assessing the patentability of the invention by the patent researcher; and (f) delivery of the assessment results to the user; and (g) billing of the user's account according to the search results.

According to further features in preferred embodiments of the invention, the submission of the request is by means of at least one of several possibilities which selected from a group consisting of post, fax, telephone conversation, verbal agreement, writing and email.

According to further features in preferred embodiments of the invention, the signed confirmation and the confirmation of obligation to confidentiality, and the proof of the date of the invention is received by means of at least one of several possibilities which selected from a group consisting of post, fax, telephone conversation, verbal agreement, writing and email.

Payment in all of the specified methods can be performed by means of the user's credit card, using the PayPal method, or by any other agreed means or method of payment.

One of the possibilities for relaying the confirmation of submission to the user is via email, another possibility is immediate display of a confirmation on the website, which can be printed and a copy of which can be saved to the user's computer. This second possibility can be applied even when the first possibility is used.

An additional possibility is for the user to receive a password, by means of which messages and results can be accessed through the website.

The patent search; assessing the patentability of the invention; and assessing the risk of patent infringement in the case of implementation can be performed by one or more individuals, for example one person performs the search, and two other pepole each perform separate assessment, which are later compared and combined into a joint assessment.

### DESCRIPTION OF THE DRAWING

The invention is herein described, by way of example only, with reference to the accompanying drawing, wherein:

FIG. 1 is a flow chart that illustrates one mode of operation of the Pay-Per-Patent-Proof system and method according to one preferred embodiment of the present invention.

### DESCRIPTION OF THE PREFERRED EMBODIMENTS

The principles and operation of a Pay-Per-Patent-Proof system and method according to the present invention may be better understood with reference to the drawing and the accompanying description.

Before explaining at least one embodiment of the invention in detail, it is to be understood that the invention is not limited in its application to the details of construction and the arrangement of the components set forth in the following description or illustrated in the drawing.

Unless otherwise defined, all technical and scientific terms used herein have the same meaning as commonly understood by one of ordinary skill in the art to which this invention belongs. The systems methods, and examples provided herein are illustrative only and are not intended to be limiting.

With the Pay-Per-Patent-Proof (PPPP) system and method the patent researcher has an obvious interest in finding prior art of the same invention. By so, the inventor may avoid many unnecessary expenses when working with a patent attorney and as a result, the authorities will have fewer applications to process. With the PPPP system and method an invention can be processed several times by several patent researchers, since the method decreases significantly the costs of any search process.

Therefore, in the case of a “patentable” invention, the inventor can submit it for filing by a patent attorney after having been examined strictly, without the inventor having to pay for this examination.

Determining the billing fee can be based on a variety of elements such as search results, for example, the fee increases according to the following user criteria:

a. prioritizing assignments by categories such as; rush, urgent, regular, on hold;

b. long duration of search time in online database;

c. selection of the field of the invention from several possible categories;

d. the types of databases searched, particularly when there is a requirement to examine the matter of patent infringement; and

e. the speed of providing final results (so that the shorter the time, the higher the billing fee).

The fee could also be determined according to legal requirements for patentability such as: whether it is unobvious; whether it has any novelty; and whether it is useful, according the type of the desired patent and the laws of the countries for which the search and assessment are being performed.

The PPPP system and method meets a hundred-year-old need for a reliable eliminator to reduce the number of patent submission applications. The widespread use of the PPPP system and method will offer such benefits:

(1) A patent application that has been examined by several information managers with a clear vested interest in finding grounds for non-patentability to its filing will reach actual examination at a higher level of quality and therefore stands a lower chance for being rejected by court of law after registration.

(2) Faster processing time of patent applications.

The PPPP system and method provided the cheapest patent search possibility and its pricing is simplified by the following equation:
SF=K*(MST/PPP)

SF (Search Fee) is the cost of the service.

MST (Maximum Search Time) is defined in advance for all searches and is in direct correlation with the cost. The longer the MST, the higher is the SF.

K is the proportion constant.

PPP (Patent Proof Percentage) is established after several patent inquiries and depends upon the professionalism of the patent researcher. As the PPP gets higher, the cost of the search gets cheaper. By using the PPPP system and method only the most professional service providers will survive.

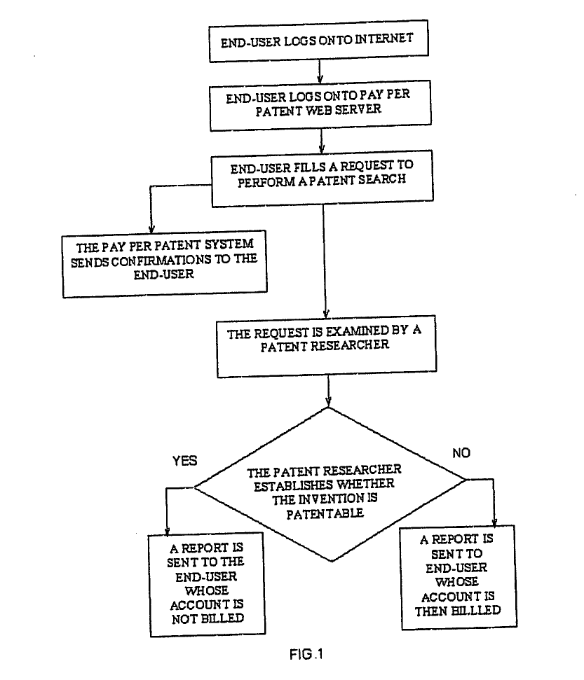

Referring now to the drawing, FIG. 1 is a flow chart that illustrates one mode of operation of the Pay-Per-Patent-Proof system and method according to one preferred embodiment of the present invention. This mode of operation commences with the first stage, when an end-user logs onto the Internet, and continues with the user's entry into the Pay-Per-Patent-Proof web server.

In the next stage, the end-user fills a request to perform a patent search. Filling this request results in two concurrent actions: the Pay-Per-Patent-Proof system sends confirmation to the end-user and the request is examined by a patent researcher.

If the patent researcher establishes that the invention is not patentable, a report is sent to the end-user whose account is then billed.

If the patent researcher establishes that the invention is patentable, a report is sent to the end-user and whose account is not billed.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method for enabling a user performing a pay per patent search for the purpose of assessing the patentability of an invention, the method comprising the following steps:
(a) said user's entry via the Internet into a pay per patent search system, said pay per patent search system including:
(i) a server, wherein said server is hosting a website loaded with dedicated software;
(b) said user's filling a request to perform a patent search, and obligation to accept billing to his account, wherein said request includes a description of said invention for said patentability assessment of which said patent search is to be performed;
(c) said user's receiving, from said pay per patent search system, a signed confirmation that is not changeable, as proof of submission of said request, confirmation of obligation to confidentiality, and proof of the date of said invention;
(d) performing patent search by a patent researcher;
(e) assessing the patentability of said invention by said patent researcher; and
(f) delivery of said patent search and said patentability assessment results to said user.

2. A method for enabling a user performing a pay per patent search for the purpose of assessing the patentability of an invention, and assessing the risk of patent infringement by implementation of said invention, the method comprising the following steps:
(a) said user's entry via the Internet into a pay per patent search system, said pay per patent search system including:
(i) a server, wherein said server is hosting a website loaded with dedicated software;
(b) said user's filling a request to perform a patent search, and obligation to accept billing to his account, wherein said request includes a description of said invention for the patentability assessment of which said search is to be performed;
(c) said user's receiving, from said pay per patent search system, a signed confirmation that is not changeable, as proof of submission of said request, confirmation of obligation to confidentiality, and proof of the date of the invention;
(d) performing patent search by a patent researcher;
(e) assessing the patentability of said invention by said patent researcher;
(f) assessing the risk of patent infringement in the case of implementation of said invention for which said patent search was performed; and
(g) delivery of said patent search, said patentability assessment, and said assessment of risk of patent infringement results to said user.

3. The method of claim 1 wherein the method further comprising the step;
(g) billing of said user's account according to said search results.

4. The method of claim 3 wherein said billing fee is none in the case that said assessment results do not indicate that said invaention is not patentable.

5. The method of claim 3 wherein the billing sum increases according to said patent search and assessment results, which are selected from a group consisting of: response time; duration of search time in databaess relevant to the field of the invention; databases necessary for the search; and time of providing results after completion of the search while the effect of the above elements on the billing fee can be determined separately.

6. The method of claim 3 wherein the method further comprising the steps;
(g) said user confirms said billing; and
(h) said user's account is billed.

7. The method of claim 2 wherein the method further comprising the step;
(h) billing of said user's account according to said search results.

8. The method of claim 7 wherein said billing fee is none, in the case that said assessment results indicate neither that said invention is not patentable nor at risk of patent infringement in case of implementation.

9. The method of claim 7 wherein said billing sum increases according to said search and said assessment results, which are selected from consisting of longer assessment time, a result indicating high likelihood of impatentability, and results indicating a higher risk of patent infringement in the case of implementation of the invention for which the patent search was performed.

10. The method of claim 7 wherein the method further comprising the steps;
(A) said user confirms said billing; and
(i) said user's account is billed.

11. A method for enabling a user performing a pay per patent search for the purpose of assessing the patentability of an invention, the method comprising the following steps:
(a) said user's filling a request to perform a patent search, and obligation for payment from the user's account wherein said request includes a description of said invention for the patentability assessment of which the search is to be performed;
(b) said user submits said request and obligation for payment to a patent researcher.
(c) said user receives, from said patent researcher, a signed confirmation that is not changeable, as proof of submission of the request, confirmation of obligation to confidentiality, and proof of the date of the invention;
(d) performing patent search by a patent researcher;
(e) assessing the patentability of said invention by said patent researcher; and
(f) delivery of said assessment results to said user; and
(g) billing of said user's account according to said search results.

12. The method of claim 11 wherein submission of said request is by means of at least one of several possibilities which selected from a group consisting of post, fax, telephone conversation, verbal agreement, writing and e-mail.

13. The method of claim 11 wherein said signed confirmation and said confirmation of obligation to confidentiality, and said proof of the date of said invention is received by means of at least one of several possibilities which selected from a group consisting of post, fax, telephone conversation, verbal agreement, writing and e-mail.
